(19) United States
(12) Patent Application Publication
(10) Pub. No.: US 2009/0134211 A1
(43) Pub. Date: May 28, 2009

(54) Method

(75) Inventor: Rango Dietrich, Konstanz (DE)

Correspondence Address: NATH & ASSOCIATES PLLC, 112 South West Street, Alexandria, VA, 22314, US

(73) Assignee: NYCOMED GmbH, Konstanz (DE)

(21) Appl. No.: 11/921,215

(22) PCT Filed: Jun. 8, 2006
(86) PCT No.: PCT/EP2006/063010

§ 371 Date: Dec. 19, 2007

(30) Foreign Application Priority Data
Jun. 8, 2005 (DE) 10 2005 026 563.4

(51) Int. Cl. G06K 7/00; G06K 19/07

(52) U.S. Cl. 235/375; 235/494

(57) ABSTRACT

The present invention relates to a method for the provision of clinical trial products in the context of clinical trials.

### TECHNICAL FIELD OF THE INVENTION

The invention relates to a method for the provision of clinical trial products in the context of clinical trials.

### PRIOR ART

Radiofrequency identification (RFID) is a technology affording new possibilities of automation in many fields of application, including in the pharmaceutical industry, for example in the logistics involved in carrying out clinical trials. The transponders used in RFID technology are usually composed of a microchip for storing data, and of an antenna for transmitting data.

Clinical trial products, in contrast to drugs that are sold on the market after approval, are distinguished, among other things, by the fact that a plurality of packaging hierarchies have to be established on an individual patient basis depending on the design of the clinical trial. The “box within a box within a box within a box” principle applies. Here, very different products can be contained at different “box depths” within an outer packaging.

In addition, the packaging is carried out according to the randomized clinical trial protocol, and the specimens have to be blinded, that is to say be packaged in an indistinguishable manner. In addition, a tamperproof seal is often required in order to indicate unauthorized opening of the packaging.

The difficulty that arises now is that, on the one hand, the relevant regulations (e.g. GMP Annex 13) require that a check be made to ensure that the blinding has been done correctly. In other words, after the packaging has been carried out, the test specimens have to be checked in respect of their identity and correct blinding, so as to prove that test medication or reference medication or active drug or placebo has been correctly allocated to the correct patient (according to the randomized allocation according to the trial protocol). On the other hand, this check can only be done by specimens being removed from all of the blinded packages and examined. For this examination, it is generally necessary to open the package, in other words to break the tamperproof seal. The check can therefore also only be carried out on specimens which in terms of quality and number have to be representative of the overall collective and, as these tests are destructive ones, these specimens cannot afterwards be returned to the collective. This results in gaps in the patent numbers, which in turn disrupt the conduct of the clinical trial.

A method would therefore be desirable which can be used on a completely closed and sealed packaging without destructive testing and visual contact (such as, for example, in the case of a barcode; for this the package would have to be opened in order to record the individual components) and not just on one specimen but instead on the entire collective so as to rapidly and reliably identify, and thus guarantee, the correct composition of all the component parts of the trial medication across all packaging levels and their correct allocation to the patient numbers in accordance with the randomization protocol of the clinical trial.

In connection with such a method, it ought also to be possible to rationalize the legally prescribed specimen count carried out after completion of the study (also called pill counting).

GB 2342203 describes a method for drug packaging, for use in carrying out clinical trials. Containers are provided which, for example, have an RFID tag and are filled with a specific drug that is to be packaged. The identity of the container and the identity of the drug located in the latter are stored in a database, together with data for inscriptions, and a tag containing the information stored in the database is applied to the container. The risk of applying the wrong tag is thereby avoided.

WO 01/94016 describes a sample container comprising a holder for receiving a sample, and an RFID unit (radiofrequency identifier) comprising an antenna for transmitting or receiving radiofrequencies, and an integrated circuit chip connected to the antenna, the RFID unit being arranged on a carrier, and the carrier being connected to the holder for receiving the sample. The holder is intended in particular for use in clinical trials. The carrier is a cylinder which is made of non-metallic material and has an RFID tag wound round it. The cylinder itself is preferably made of plastic which is connected as cap or directly to the aerosol container by means of synthetic resin adhesive.

US 2004/0046020 is related to a medication-dispensing unit which is provided for tracking medical product having a Radio Frequency Identification (RFID) tag uniquely associated therewith.

EP 1561689 is related to process control and documentation of packaging of individual packages each having an individual package transponder, comprising characterizing information capable of documenting the package with a first writing unit registering in each transponder, reading information from the transponders before the individual packages are packaged, and controlling commencement of operations of processing in response to correct information.

DE 10010140 is related to an apparatus for preferably automatic handling and/or processing of objects, in particular in the field of medical technology, having at least one processing station and one object carrier for bringing the object to the processing station, optionally through the processing station, and away from the processing station, is characterized in that the object carrier has a code; that data concerning the object and/or the handling or processing of the object can be assigned to the code; and that the data can be read or retrieved by way of the code.

### DISCLOSURE OF THE INVENTION

Surprisingly it has now been found that the above-described desirable method for the provision of test specimens in the context of clinical trials can be realized by means of RFID. By application of pre-coded RFID tags to all packaged medication components of the primary and secondary packaging levels (in other words the actual medication and all of the surrounding packagings) and by suitable arrangement within the packaging, it has been shown that it is possible to guarantee complete recording of all the trial products contained in a packaging.

It is thus surprisingly possible, in light of the problems set out above, to make a complete identity check of all the medication components of clinical trial products even at considerable box depths, on this basis to achieve a parametric release of the medication under the aspect of “Identity check for correct randomization” according to GMP Annex 17, and thereby dispense with the analytical chemistry identification check and determine rapidly and in a contactless manner, at the time of return of medication at the end of the study, which medication packages have been returned, and to forward these for counting. The rationalization effect in conjunction with the improved quality (since the identity check no longer has to be restricted only to the tested specimen and instead applies to the entire collective) and accelerated execution of the legally prescribed procedures is enormous.

The subject of the invention is therefore a method for the provision of clinical trial products in the context of clinical trials, comprising the following steps:
(a) applying an RFID unit to the primary packaging of a trial product,
(b) arranging one or more primary packagings, obtained after step (a), inside a secondary packaging,
(c) applying an RFID unit to the secondary packaging obtained in (b),
(d) arranging one or more secondary packagings, obtained after (c), inside a common outer packaging,
(e) optionally applying an RFID unit to the outer packaging, and
(f) recording all the packaging components by means of the RFID units.

According to the invention, trial products are to be understood as presentation forms of active substances or placebos which are tested in a clinical trial on humans or are used as comparison products or are employed to generate certain reactions in humans. According to the invention, this term covers drugs that are not approved and also approved drugs when these are used in the context of a clinical trial on humans or animals in a presentation form other than the one that has been approved or for an indication that has not been approved or for gaining additional information on the approved drug. Examples of presentation forms that may be mentioned are solid oral forms (e.g. tablets, capsules, pellets), inhaled forms (e.g. aerosol formulations, dry powder for inhalation), presentation forms for parenteral administration (e.g. infusions, injections), semi-solid forms (e.g. ointments, creams, suppositories) and transdermal therapeutic systems.

Primary packaging, according to the invention, is to be understood as the container or other form of packaging which is in direct contact with the trial product. Examples that may be mentioned are blister packs, cartons, tubes, bottles, ampoules, stoppered vials, metered dose inhalers, drug powder inhalers, sachets and sealed pouches. Secondary packaging, according to the invention, is to be understood as a packaging in which one or more identical or different primary packagings are received. In general, secondary packagings are cardboard boxes or folding boxes in all conceivable formats, wall thicknesses and designs, colours and surfaces, for manual and automatic construction and delivery, blank for subsequent tagging, or pre-printed.

According to the invention, the arrangement of primary packagings in a secondary packaging is preferably done in an ordered manner. It has proven advantageous in this respect if the surfaces of the primary packagings that comprise a tag according to the invention are oriented as far as possible parallel to one another (also stacked one on top of another) and are not perpendicular to one another. This is preferably done by applying the tag always on the same side of the primary packaging and correspondingly arranging the units in the secondary packaging. If the primary packaging is round (e.g. bottles), particular attention must be paid to the described arrangement in the secondary packaging, because, in the event of rotation of the round containers in the secondary packaging, the tag according to the invention may end up in an unfavourable (i.e. non-parallel) orientation relative to the other components of the secondary packaging, thus making recording of the units difficult. According to the invention, one or more identical or different primary packagings can be received in a secondary packaging.

According to the invention, outer packaging is understood as packaging in which one or more identical or different secondary packagings can be received. The arrangement of the secondary packagings in a common outer packaging is preferably done in an ordered manner. Care must be taken to ensure that the surfaces of the boxes of the secondary packaging that comprise a tag according to the invention are oriented as far as possible parallel to one another (also stacked one on top of another) and are not perpendicular to one another. This is done by applying the tag always on the same side of the box and correspondingly arranging the boxes in the outer packaging. It is also possible to receive one or more outer packagings with or without RFID units in any desired additional outer packagings. This results in a test specimen pack also called test specimen shipper or RFID specimen shipper.

The RFID unit (according to the invention also called transponder) comprises, according to the invention, a microchip (hereinafter referred to as chip) for storing data, and an antenna for receiving or transmitting data. At the time of production, the microchip is given a globally unique code and is connected to the antenna, and both can be applied on a common carrier. An energy source can also form a component part of the RFID unit. Various RFID units are commercially available which operate with defined frequencies in the range of 50 KHz to 2.5 GHz. The 13.56 MHz systems are particularly suitable for applications with metals and liquids. Examples that may be mentioned are commercially available systems such as the OBID I-scan HF reader family with the corresponding transponders from Philips, Infineon and Texas Instruments.

According to the invention, RFID units are preferred which are connected to a tag. The tag is preferably of paper, polyethylene or of other carrier materials known to a person skilled in the art and has a self-adhesive layer. The tag is preferably structured such that the RFID unit and the tag form one unit, the RFID unit being applied on the rear/lower part of the tag, between carrier material and adhesive layer.

In one embodiment of the invention, in particular for application on metallic substrates, the RFID unit is positioned between the tag and the adhesive layer. To do this, the adhesive layer of the tag can be lightly foamed (0.2-0.4 mm) so that the raised parts of the RFID unit can be pressed into the adhesive layer. This means that the tag can be left with as large as possible a surface area to be printed on.

The tag containing the RFID unit can be printed with the variables typical of the study, and the microchip contained in the RFID unit can be coded with a numerical or alphanumerical code. According to the relevant regulations (e.g. GMP Annex 13), this code is an admissible replacement for the indication of the batch reference for demonstrating in clinical studies which patient has received which medication from which clinical study, without unblinding the study in order to do so. It is therefore necessary to give the code a structure that not everyone can understand. The code can then be used, for example, for tracing the correct randomization and the distribution chain. The code is preferably generated by a higher-order IT system (e.g. MES=manufacturing execution system) and is linked logically to the associated packaging step. The link is generally created in the packaging procedure, by a tag according to the invention with RFID being assigned to a certain medication or patient package and affixed. The code can then contain, for example, the patient number, the packaging level, the medication, the study title, the name of the trial centre, etc. in encrypted form. In manufacturing execution systems, the code can be generated in conjunction with the creation or drafting of the packaging directions (on paper, or electronically, then called electronic batch records) from the details of the packaging design.

Alternatively, the RFID chip contains only the globally unique code applied already during the production of the chip, which code initially has no relationship to the packaging sequences. In the latter case, the code has to be read out at the time of application of the tag and, for each individual packaging step, has to be linked logically in the higher-order information management system to the associated packaging step.

The units provided with a (pre-coded or system-coded) RFID are then applied to the packaging of the respective packaging hierarchy level (primary packaging, secondary packaging or outer packaging). This is preferably done by means of the self-adhesive layer of the tag containing the RFID unit being affixed to the package. This procedure is repeated for as many times as there are different packages at different packaging depths in accordance with the design of the clinical study. A packaging collective of greater or lesser complexity is obtained consisting of several components. According to the invention, one or more RFID units can be applied to a primary packaging, secondary packaging or outer packaging.

According to the invention, the packaging components are recorded by means of the RFID units preferably via a reader, with which the data stored on the RFID units can be read out and transferred to an electronic database. This can be stored in a PC (personal computer) or be part of a higher-order information management system.

Since all the components carry an RFID unit, all of the components contained in the packaging collective can now be identified in one operating step (i.e. simultaneously) without destructive opening of the packaging and without any visual link. Since each unit acquires, via the code, the information concerning for which patient the respective package is intended and shows which medication it contains, the sum of the individual information items on the packaging level can be used to characterize the entire packaged collective. Non-destructive testing for correct blinding and randomization which in terms of its expressiveness goes far beyond the results of an analytically tested random sample (destructive testing). Since the whole collective can be recorded and the correct assignment of the code is effected already in the respective packaging step and a plausibility check is made there, it is possible in this way to determine and prove the correct allocation of the packaging units in the overall collective. This process of tests and proof of correctness on the basis of data acquired during the production process is called “parametric release”.

Since the data of the individual packaging components including the encrypted information on patient number, study number and trial centre number are contained in the code, this information can be used at the end of the trial for evaluation purposes. In contrast to commercial goods, test specimen packagings are returned after use in the empty or opened state. These used packages are used to evaluate how much medication the individual patient has taken and on this basis to decide whether the patient can or cannot be included in the assessment of the study. The necessary recording of each individual package and the allocation to the study and patient can be rationalized by automatic recording of the information stored in the RFID. Since in contrast to the barcode, no visual link is needed with RFID, a complete shipment unit with several hundred patient packages can in theory be recorded simultaneously, without each individual package having to be separately handled (as in the case of a barcode).

### BRIEF DESCRIPTION OF THE FIGURES

FIG. 1a shows components of an RFID system.

FIG. 1b shows a block diagram of an RFID unit with memory function.

FIG. 2a shows a tag with an RFID unit.

FIG. 2b shows the layered structure of an RFID unit with foamed spacer layer (section IIb-IIb in FIG. 2a).

FIGS. 3a-3d shows different secondary packagings in an outer packaging (test specimen pack or RFID specimen shipper).

FIG. 4 shows the recording of all the packaging components of an RFID specimen shipper.

### DETAILED DESCRIPTION OF THE INVENTION WITH REFERENCE TO THE FIGURES

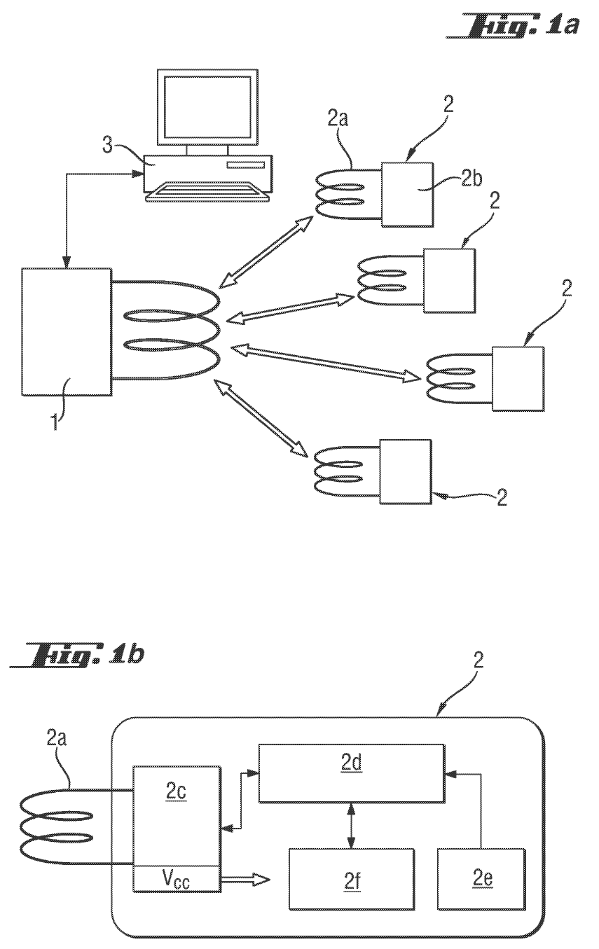

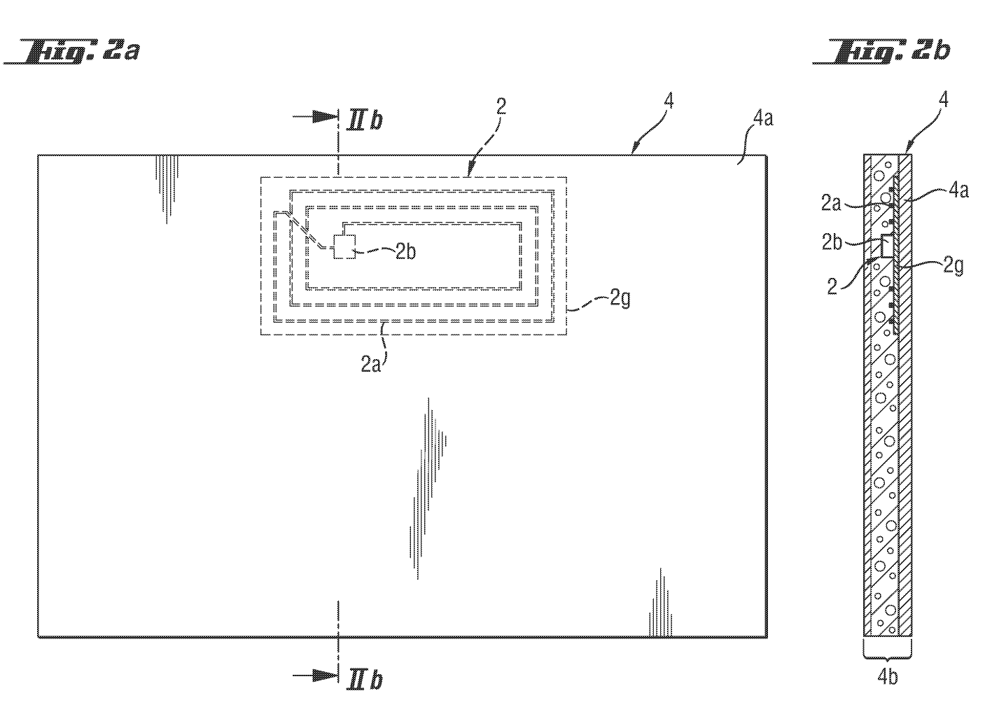

FIG. 1a shows a schematic representation of the component parts of an RFID system. Data stored on RFID units (2) can be read out via a reader (1) and transferred into an electronic database (3). This can be stored on a PC (personal computer) or be part of an information management system.

The reader (1) transmits radiofrequency energy to the RFID unit or receives radiofrequency energy from there. The reader can, for example, be a long-range RFID reader with gate or tunnel antenna. A particularly effective application for bulk recordings with critical media (metals, liquids) is the long-range reader for 13.56 MHz systems with plexed 3D tunnel antenna. The reader generates a high-frequency electromagnetic field which at the transponder level induces an oscillation circuit whose resonant frequency corresponds to the transmit frequency. By means of load modulation at transponder level, the amplitude of the voltage on the oscillation circuit also changes. This principle is used to transmit data in both directions. The RFID transponder (2) is made up of an antenna (2a) connected to a microchip (2b). The microchip is composed of the following 4 modules as HF interface (2c), address and safety logic (2d), ROM (2e) and EEPROM (2f). In the ROM, the RFID transponder is inscribed with a unique ID. (Name, manufacturer, UID 64 bit-92 bit). The EEPROM serves to record data (384 bit-7 kbit). FIG. 1b

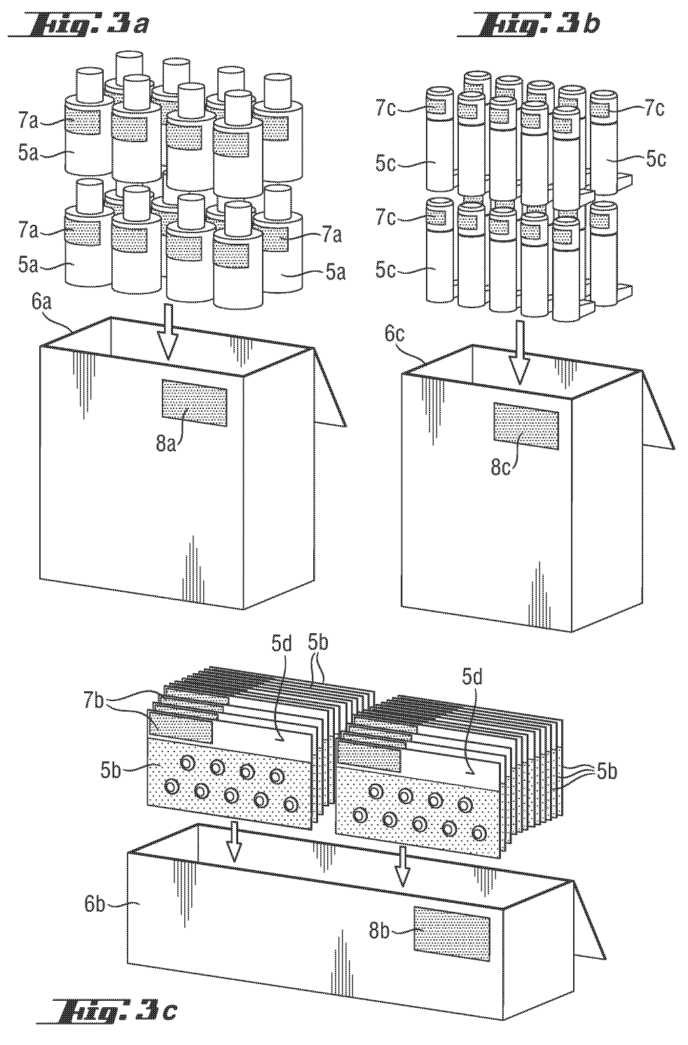

FIG. 2a shows an RFID unit (2) which is connected to a tag (4). The tag is of paper, polyethylene or of any other customary carrier materials that can be printed on and are known to a person skilled in the art and it has a self-adhesive layer. The tag is structured in such a way that the RFID unit and the tag form one unit, the RFID unit being applied on the rear part of the tag, between carrier material (4a) and adhesive layer (4b). In one embodiment of the invention (in particular for use on metal supports), the RFID unit (2) is positioned between the carrier material (4a) and the adhesive layer (4b); to do this, the adhesive layer (4b) of the tag is lightly foamed (0.2-0.4 mm), so that the raised part of the RFID unit (2) can be pressed into the adhesive layer. This makes it possible to leave free a large surface area that can be printed on. The required texts can be printed onto this surface area. The RFID unit (2) in this embodiment is a passive 13.56 MHz RFID unit (microchip connected to an antenna without energy source) placed on a support film (2g). An example that may be mentioned is the ISO Philips semiconductor transponder with dimensions of 32×16 mm. This can be read out with a reader (1) in the form of a 13.56 MHz long-range RFID reader with gate or tunnel antenna.

In a first step, the required RFID unit is prepared in the form of tags in accordance with the information which is stored in a database or higher-order information management system for the packaging unit that is to be produced in the context of the clinical trial. The task of printing the tag can be undertaken by an RFID thermal transfer printer (integrated RFID writer-reader) which simultaneously prints the RFID tag, checks the functionality of the RFID transponder and inscribes or reads out the transponder. For example, in this process the UID (64 bit) of the transponder can be read out and linked with the table entry for this tag in the database of the management system. (RFID-UID and information on the print content are linked in the database and can be utilized for automatic checks).

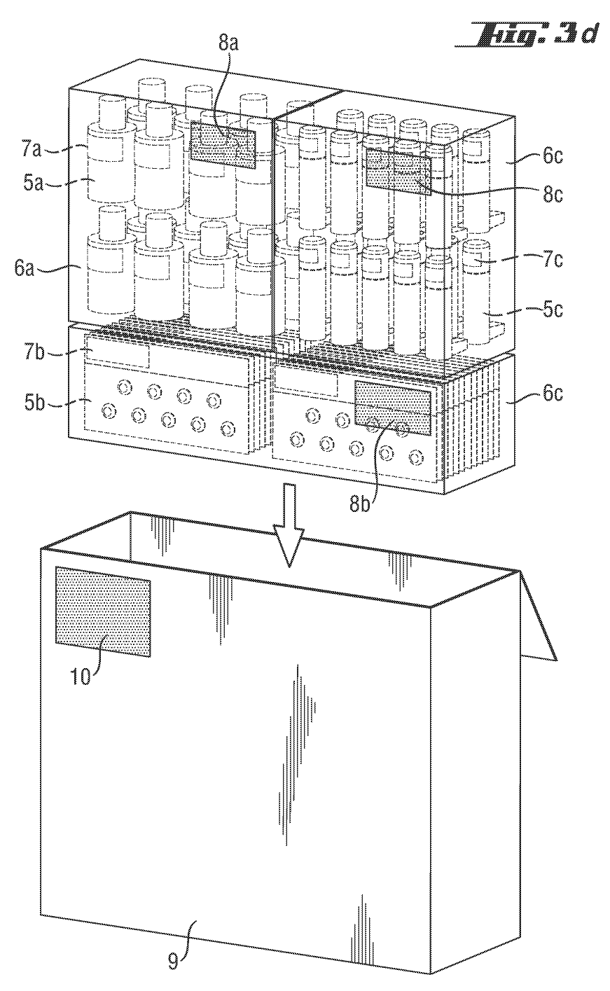

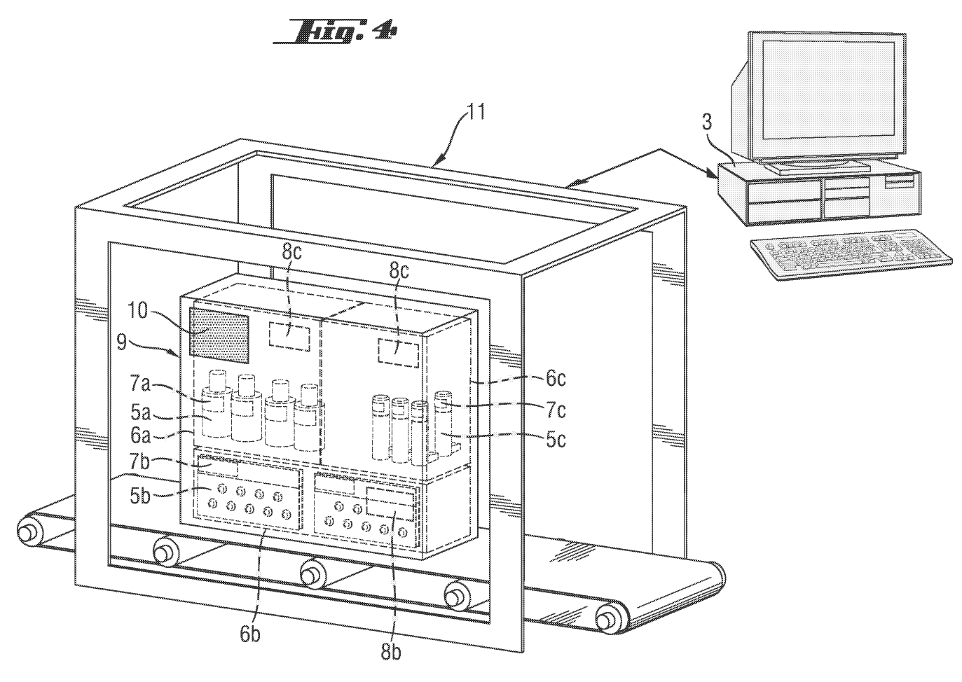

As shown in the FIGS. 3a to 3d, primary packagings in the form of bottles (5a) blister packs (5b) and aerosol containers (5c) and secondary packagings (6a, b, c) are organized according to the packaging directions, provided with the corresponding RFID tags 7 a, b, c and then checked for identity and the correct numbers. In connection with blister packs (5b) which contain suitable metals such as aluminium as components (aluminium blisters) the RFID-tags (7b) are preferably placed on the blister on a metal free area (5d) such that there is no overlapping of the antenna of the transponder with the metal surface of the blister. Such metal free compartment can for example be obtained by partially removing the aluminium layer of an aluminium blister. It is advantageous for the antenna of the transponder to be arranged in direct or close contact with the metal surface of the blister, since a strengthening of the antenna action can in this way be achieved.

The secondary packagings are organized according to the packaging directions, provided with RFID tags 8a, b, c and then checked for identity and the correct numbers on the basis of the data stored in the RFID. The test specimen shipper 9, which can likewise be provided with an RFID tag 10, is organized according to packaging directions and then checked for identity and the correct numbers. According to FIG. 4, in the final check the test specimen shipper 9 is pushed into an RFID tunnel reader 11 and thus checked for identity and the correct numbers. At the same time reference is made to the database 3 of the electronic management system, and complete documentation of all the GMP production processes carried out on this product and its checks has to be verified by the head of production and released.

1. A method for the provision of clinical trial products in the context of clinical trials, comprising the following steps:
(a) applying one or more RFID units to a primary packaging of a trial product,
(b) arranging one or more primary packagings, obtained after step (a), inside a secondary packaging,
(c) applying one or more RFID units to the secondary packaging obtained in (b),
(d) arranging one or more secondary packagings, obtained after (c), inside a common outer packaging,
(e) optionally applying one or more RFID units to the outer packaging, and
(f) recording all the packaging components by means of the RFID units.

2. The method according to claim 1, in which the RFID units are connected to a tag, and the tag comprises a printable carrier material and a self-adhesive layer.

3. The method according to claim 2, in which the RFID unit is a pre-coded RFID unit.

4. The method according to claim 1, in which an RFID unit is applied to each of the primary packagings.

5. The method according to claim 1, in which an RFID unit is applied to each of the secondary packagings.

6. The method according to claim 1, in which the trial product is a non-approved drug.

7. The method according to claim 1, in which the trial product is a presentation form selected from the group comprising solid oral forms, inhaled forms, presentation forms for parenteral administration, semi-solid forms and transdermal therapeutic systems.

8. The method according to claim 7, involving two or more trial products.

9. The method according to claim 1, in which the primary packaging is a packaging selected from the group comprising blister packs, cartons, tubes, bottles, ampoules, stoppered vials, metered dose inhalers, drug powder inhalers, sachets and sealed pouches.

10. The method according to claim 9, involving two or more primary packagings.

11. The method according to claim 1, in which the recording carried out in step (f) is effected via an RFID reader with which the data stored on the RFID units can be read out and transferred into an electronic database.

12. The method according to claim 1, in which step (b) comprises arranging two or more primary packagings, obtained after step (a), inside a secondary packaging.

13. The method according to claim 1, in which step (d) comprises arranging two or more secondary packagings, obtained after step (c), inside a common outer packaging.

14. The method according to claim 1, in which the recording carried out in step (f) is effected in one operating step.

15. The method according to claim 1, comprising after step (f) the following steps:
(g) sending the obtained RFID specimen shipper to a clinical trial site and
(h) recording the content of the RFID specimen shipper after provision of the clinical trial products to patients.

16. A test specimen shipper comprising an outer packaging which has an RFID unit and contains one or more secondary packagings, the secondary packagings each having one or more RFID units, the secondary packagings containing one or more primary packagings, and the primary packagings having one or more RFID units.

17. The test specimen shipper according to claim 16, in which one or more trial products are contained in the primary packagings.
